(19) United States
(12) Patent Application Publication
(10) Pub. No.: US 2004/0224840 A1
(43) Pub. Date: Nov. 11, 2004

(54) Catalyst for removing aromatic halogenated compounds comprising dioxin, carbon monoxide, and nitrogen oxide and use thereof

(75) Inventors: Du-Soung Kim, Seoul (KR); Jihn-Koo Lee, Seosan-si (KR); Bong-Soo Kim, Seosan-si (KR); Seung-Jae Lee, Seosan-si (KR); Myoung-Jin Kha, Seosan-si (KR)

Correspondence Address: GREENBLUM & BERNSTEIN, P.L.C., 1950 ROLAND CLARKE PLACE, RESTON, VA, 20191, US

(73) Assignees: KOCAT INC., Seoul (KR); DONG YANG CONSTRUCTION CO., LTD., Pohang-si (KR)

(21) Appl. No.: 10/726,551

(22) Filed: Dec. 4, 2003

(30) Foreign Application Priority Data
May 3, 2003 (KR) 10-2003-0028373

(51) Int. Cl. B01J 23/68

(52) U.S. Cl. 502/309

(57) ABSTRACT

The present invention relates to a catalyst for removing aromatic halogenated compounds comprising dioxin, carbon monoxide and nitrogen oxide simultaneously and a method for preparing the catalyst, more particularly, a catalyst comprising 0.1 to 5% by weight of vanadium, 1 to 12% by weight of metals in 6A family and 0.1 to 10% by weight of Ag in titania carrier or, alternatively, a catalyst produced by impregnating said catalyst in 0.05 to 1M sulfuric acid solution to carry out acid treatment.

The catalyst according to the present invention has improved efficiency for removing 1,2-dichlorobenzene as a reactant model of dioxin and carbon monoxide rather than existing catalysts and also, alternative efficiency for removing nitrogen oxide substantially equal to commonly known catalysts, so that the catalyst can effectively control various air pollutants contained in exhaust gas.

### BACKGROUND OF THE INVENTION

1. Field of the Invention

The present invention relates to a catalyst for removing aromatic halogenated compounds comprising dioxin, carbon monoxide and nitrogen oxide simultaneously and a method for preparing the catalyst, more particularly, a catalyst comprising 0.1 to 5% by weight of vanadium, 1 to 12% by weight of metals in 6A family of the periodic table and 0.1 to 10% by weight of Ag in titania carrier or, alternatively, a catalyst produced by impregnating said catalyst in 0.05 to 1M sulfuric acid solution to undergo an acid treatment.

2. Description of the Related Art

Since incineration of waste is one of the most effective treatment processes in view of reduction of volume of the waste and recovery energy used in the process, it is widely used in countries with high density of population and lack of landfill areas such as Korea. However, in recent times, requirement for environmental protection against air pollution increasingly comes to the front, thus it necessarily needs removal of air pollutants such as dioxin, carbon monoxide and nitrogen oxides contained in exhaust gas and produced during incineration of the waste.

Dioxin which is one of the main air pollutants is well known as an organic compound having two benzene rings linked together by oxygen and, is a general name for polychlorinated dibenzo-p-dioxins (PCDDs) comprising 75 isomer types; and polychlorinated dibenzofurans (PCDFs) including 135 isomer types. Such compounds express different chronic toxicities as well as acute toxicity and are widely identified as harmful materials generating other effects such as immuno-toxicity, genital system toxicity, and cancer-inducing effect and so on. Origins to induce generation of the dioxin are not limited to, but include (1) incineration facilities located in or near residential areas such as city, (2) industrial processes such as steel works, metal refinery, (3) pulp manufactory, (4) automobile exhaust gas and (5) chemical industry to produce and management chemicals such as agricultural medicines or chlorophenol, etc. In case of the incineration facilities as a representative place for generating the dioxin among them, it is possible to prevent generation of dioxin if a complete combustion of waste is attained with sufficient amount of oxygen within a trash burner to result in generation of carbon dioxide and water. But, when the incinerating time is shorter and causes lack of the oxygen required, it leads to incomplete combustion and generation of precursor for dioxin, followed by generation of dioxin through reaction of the precursor with chlorine.

As another origin of air pollution, carbon monoxide has a bonding ability to hemoglobin in blood higher than to oxygen by about 200 times and if it exists in high concentration in atmosphere, the carbon monoxide inhibits activation of hemoglobin and may threaten life of human being, and is well known as one of main contaminants causing the environmental pollution such as greenhouse effect.

Nitrogen oxides, the other origin of air pollution, have been known to generate smog by photo-chemical reaction, as well as one of principle materials causing acid rain.

Among conventional processes to remove such above listed compounds, it has been most extensively disclosed to use particular catalysts, more particularly, a process to flow exhaust gas containing dioxin on a catalyst layer and to allow oxidation of dioxin with oxygen in the exhaust gas, thereby decomposing dioxin into carbon dioxide, water and hydrogen chloride or chlorine is well known. Further, activated carbon has been used to adsorb dust, heavy metals and dioxin in the exhaust gas. However, it has disadvantages such as a difficulty in regeneration and/or disposal of the activated carbon adsorbed with the dioxin and great treatment expenses required. Among the processes for removing carbon monoxide, a catalytic oxidation method with noble metals or transition metals is mostly used, which is to completely oxidize the carbon monoxide into carbon dioxide to result in removal thereof. As one of conventional processes for removing nitrogen oxides, mostly known is a selective catalytic reduction (SCR) with particular catalyst which reacts the nitrogen oxides with ammonia on the catalyst to decompose it into nitrogen and water.

Above mentioned processes to remove such environmental contaminants will be described in detail with reference to prior arts proposed and disclosed before the present invention as follows:

U.S. Pat. No. 5,430,230 describes a process to increase oxidation performance for dioxin and carbon monoxide, more particularly, a process for preparing a novel catalyst which comprises replacing conventional catalyst containing titania carrier, vanadium and tungsten with titania-silica, titania- zirconia and/or titania-silica-zirconia; adding one or more elements selected from a group consisting of molybdenum, vanadium, cerium, tin and tungsten; providing and supporting one or more elements selected from a group consisting of copper, rhodium, ruthenium, manganese, platinum, iron, chromium and palladium on outer surface of the above resulted material. U.S. Pat. No. 5,653,949 proposed a process for removing halogenated hydrocarbon and carbon monoxide with a catalyst which was produced by introducing one or more elements selected from a group consisting of zirconia and manganese, cerium and cobalt; adding one or more noble metals selected from a group consisting of platinum, palladium and rhodium. U.S. Pat. No. 6,027,697 disclosed a process for removing dioxin and nitrogen oxides comprising to add one or more elements selected from a group consisting of molybdenum, yttrium, boron, tin and lead to the catalyst containing active materials such as titania carrier, vanadium and tungsten.

Under consideration of such patented inventions described above, since reaction of the nitrogen oxides proceeds in the reduction atmosphere while the dioxin and the carbon monoxide react in the oxidation atmosphere if the air pollutants are eliminated by the carriers and catalysts having high oxidation ability, the cited inventions show a reduced efficiency of removal for the nitrogen oxides although both of the dioxin and the carbon oxides can be effectively removed. In addition to, when adding noble metals to the catalyst in order to enhance activity of the catalyst, it causes problems such as price increase and limitation of applicable amount of the catalyst.

Accordingly, there is an urgent need for manufacturers in related industries such as incineration facilities to develop efficient and economical process for treating exhaust gas.

A portion of this invention was disclosed in the publication, ‘Program and Abstract of 2003 spring seminar’, by the Korean Institute of Chemical Engineers on Apr. 25, 2003, the content of which is incorporated hereinto by reference.

### SUMMARY OF THE INVENTION

The present inventors have conducted extensive study and development to solve subject problems involved in conventional arts described above and, found out that it is possible to maintain the removal efficiency of aromatic halogenated compounds such as dioxin and carbon monoxide to a higher level while keeping the removal efficiency of nitrogen oxides substantially equal to a level provided by conventional catalysts following selective catalytic reduction processes if a novel catalyst is produced by preparing a first catalyst [V—Mo(W or Cr)/TiO₂] comprising active materials such as vanadium and metals in 6A family, for example, molybdenum or tungsten or chromium on titania carrier; adding Ag as a noble metal having relative low price to the first catalyst to produce a second catalyst [Ag—V—Mo(W or Cr)/TiO₂]; and/or, additionally, carrying out acid-treatment of the second catalyst to give a final catalyst [Ag—V—Mo(W or Cr)/TiO₂—SO₄²⁻].

It is, therefore, an object of the present invention to provide a catalyst for removing aromatic halogenated compounds comprising dioxin, carbon monoxide and nitrogen oxides simultaneously and a process for producing the same.

In an aspect of the invention, the present invention provides a catalyst comprising 0.1 to 5% by weight of vanadium, 1 to 12% by weight of any metal from 6A family and 0.1 to 10% by weight of Ag in 70 to 99% by weight of titania useful to remove the aromatic halogenated compounds comprising dioxin, carbon monoxide and nitrogen oxides simultaneously.

In another aspect of the invention, the present invention provides alternative catalyst by additionally conducting acid treatment of the catalyst produced above useful to remove the aromatic halogenated compounds comprising dioxin, carbon monoxide and nitrogen oxides simultaneously.

### BRIEF DESCRIPTION OF THE DRAWINGS

The above object, features and advantages of the present invention will become more apparent to those skilled in the art from the following detailed description including preferred examples when taken in conjunction with the accompanying drawing, in which:

FIG. 1 illustrates conversion rates of 1,2-dichlorobenzene by catalysts produced by Examples 2 and 3 according to the present invention and Example 1 as a control for a purpose of comparison;

FIG. 2 illustrates conversion rates of carbon monoxide by catalysts produced by Examples 2 and 3 according to the present invention and Example 1 as a control for a purpose of comparison;

FIG. 3 illustrates conversion rates of nitrogen oxides by catalysts produced by Examples 2 and 3 according to the present invention and Example 1 as a control for a purpose of comparison;

FIG. 4 illustrates conversion rates of 1,2-dichlorobenzene by catalysts produced by Examples 8 and 9 according to the present invention and Example 7 as another control for a purpose of comparison;

FIG. 5 illustrates conversion rates of carbon monoxide by catalysts produced by Examples 8 and 9 according to the present invention and Example 7 as another control for a purpose of comparison; and

FIG. 6 illustrates conversion rates of nitrogen oxides by catalysts produced by Examples 8 and 9 according to the present invention and Example 7 as another control for a purpose of comparison.

### DETAILED DESCRIPTION OF THE PREFERRED EMBODIMENT

The present invention will be described in detail with reference to preferred embodiments, which is only for illustrating the present invention without limitation thereof.

As a preferred embodiment of the present invention, a catalyst comprises titania carrier as a primary component, vanadium, 6A family metals and Ag useful to remove aromatic halogenated compounds comprising dioxin, carbon monoxide and nitrogen oxides simultaneously.

As another preferred embodiment of the present invention, a catalyst comprises titania carrier as a primary component, vanadium, 6A family metals and Ag and is prepared by additional acid treatment of a primary catalyst comprising said components useful to remove aromatic halogenated compounds comprising dioxin, carbon monoxide and nitrogen oxides simultaneously.

In order to remove aromatic halogenated compounds comprising dioxin, carbon monoxide and nitrogen oxides simultaneously, the present inventive catalyst may use titania (TiO₂) capable of both oxidation and reduction at the same time. The catalyst preferably contains such titania in 70 to 99% by weight. The titania has specified crystal structures classified by anatase type, rutile type and/or amorphous type. Since the performance of catalyst for simultaneously removing aromatic halogenated compounds comprising dioxin, carbon monoxide and nitrogen oxides if a lot of anatase type crystals exist in the titania, the present catalyst may preferably contain the titania carrier having such anatase type structure among the above three types. Accordingly, the present invention adopted the anatase type titania, in particular, having a crystal structure of anatase content 100% with a specific surface area of 80 to 100 m²/g, 1 to 2% by weight of SO₃ content as the carrier.

Vanadium (V) used in the present invention as one of the primary components is already known to be mostly applied in metallic oxides catalysts in SCR processes. “Selective catalytic reduction (SCR)” means a process for transferring nitrogen oxide into nitrogen (gas) in the presence of catalyst by using any reducing agent such as ammonia or hydrocarbon. Herein, the vanadium used in the present invention has excellent reduction ability to nitrogen oxide and also has an oxidation activity to dioxin. Amount of the vanadium added in the present inventive catalyst may be preferably 0.1 to 5% by weight. Such range was defined by a reason that the performance of catalyst remarkably decreased when it is less than 0.1% by weight, while hardly increasing even for more than 5% by weight of the vanadium content.

As a cocatalyst component useable in the present invention, 6A metal comprises any one selected from a group consisting of molybdenum (Mo), tungsten (W) and chromium (Cr). Such 6A metal means any metals belonging in 6A family of the periodic table and able to increase electron density of the catalyst to allow the oxygen coupled with pollutants to be easily adsorbed to surface of the catalyst. Amount of the 6A metal added in the present inventive catalyst may be preferably 1 to 10% by weight. If it is less than 1% by weight, the performance of catalyst greatly decreases while it hardly increases even by exceeding the amount of 6A metal more than 10% by weight.

Specified catalyst [V—Mo(w or Cr)/TiO₂] comprising both of said proposed main catalyst, that is, vanadium and at least one of 6A metals selected from a group consisting of Mo, W and Cr exhibits relatively and notably higher efficiency for removal of aromatic halogenated compounds comprising dioxin, carbon monoxide and nitrogen oxide, compared to the catalyst added with any one of the main catalyst or the cocatalyst components.

Finally, the present invention provides a catalyst which is produced by adding Ag to said catalyst [V—Mo(w or Cr)/TiO₂] prepared as described above in order to enhance the efficiency for removing aromatic halogenated compounds comprising dioxin, and carbon monoxide.

Conventional catalysts usually comprises at least one selected from noble metals, in particular, from a group consisting of rhodium, ruthenium, platinum, iridium and palladium as the cocatalyst. However, such noble metals are more expensive than Ag and leads to extremely higher cost of the catalyst causing difficulties to be commercially available. Furthermore, since the removal efficiency of the nitrogen oxide exceedingly decreases in case of adding the noble metals to the catalyst compared with Ag, the noble metal cannot be used in the present inventive catalyst to remove various air pollutants against atmospheric environment.

Therefore, the present invention comprises Ag with relatively lower price than other noble metals useful to remove aromatic halogenated compounds containing dioxin, carbon monoxide and nitrogen oxide at the same time.

The Ag component added to the catalyst according to the present invention may comprise any one selected from a group consisting of AgNO₃, AgCl, Ag₂SO₄ or a combinations thereof and preferably contain Ag in an amount ranging from 0.1 to 10% by weight. If the amount is less than 0.1% by weight, the performance of catalyst greatly decreases while it hardly increases even by exceeding the amount of Ag more than 10% by weight.

Furthermore, the present invention may provide a catalyst [Ag—V—Mo(W or Cr)/TiO₂—SO₄²⁻] comprising sulphate produced by additionally impregnating the above catalyst [Ag—V—Mo(W or Cr)/TiO₂] in aqueous sulfuric acid solution then undergoing acid-treatment of the resulted solution. The obtained catalyst after the acid-treatment exhibits increase of the efficiency for removing aromatic halogenated compound comprising dioxin and carbon dioxide while keeping the level of efficiency for removing nitrogen oxide substantially the same to the conventional catalyst, that is, [V—Mo(W or Cr)/TiO₂].

The aqueous sulfuric acid solution may preferably contain 0.05 to 1M sulfuric acid because the catalytic performance greatly decreases if the content is less than 0.05M, while the performance does not increase any more even by exceeding it more than 1M.

Alternatively, the catalytic performance of the present invention substantially does not decrease when passing by sulfur dioxide on the catalyst, other than the impregnation of the catalyst with the aqueous sulfuric acid solution as the acid-treatment method.

In order to remove aromatic halogenated compounds comprising dioxin, carbon monoxide and nitrogen oxide at the same time by using the catalyst according to the present invention, the catalyst should have a reaction temperature ranging from 250 to 550° C. and a space velocity of exhaust gas ranging from 1,000 to 10,000 hr⁻¹ to give improved efficiency for removal of said pollutants. When the reaction temperature is less than 250° C., the performance of catalyst is reduced due to lack of activation energy required to convert the reactant. And, if exceeding 550° C., the performance of catalyst also decreases because of sintering effect of the catalyst. On the other hand, high investment cost required to a processing construction for removing air pollutants while attaining enhanced removal efficiency thereof results from the space velocity less than 1,000 hr⁻¹. If the space velocity is more than 10,000 hr⁻¹, the pollutants cannot contact the catalyst sufficiently because of the residential time being shorter, and the removal efficiency is remarkably reduced.

Moreover, ammonia is applicable as a reducing agent to remove nitrogen oxides under the condition listed above by incorporating it together with the catalyst according to the present invention.

The catalyst according to the present invention for simultaneously removing aromatic halogenated compounds comprising dioxin, carbon monoxide and nitrogen oxide can be obtained by any common methods in related art, in particular, comprising:

(a) a step to impregnate titania carrier with 0.1 to 5% by weight of vanadium and 1 to 12% by weight of 6A metal after agitating them to form a dissolved solution;

(b) a step to dry the titania carrier obtained from (a) at 100 to 120° C. for about 4 hours, then, to calcinate the dried carrier by increasing the temperature up to about 500° C. for 2 hours by 10° C. per minute; and

(c) a step to impregnate the titania carrier resulted from (b) with 0.1 to 10% by weight of Ag and to dry it at 100 to 120° C. for about 4 hours, followed by calcinating the dried carrier by raising the temperature up to about 500° C. for 2 hours by 10° C. per minute.

The above process to produce the present inventive catalyst may further include an additional step for conducting acid-treatment comprising to impregnate the primarily produced catalyst in 0.05 to 1M aqueous sulfuric acid solution, to dry it for 24 hours as it is then at 100 to 120° C. for about 4 hours, followed by calcinating the dried carrier by raising the temperature up to about 500° C. for 2 hours by 10° C. per minute.

The catalyst prepared by the above process comprises any one selected from a group consisting of Mo, W and Cr as the 6A metal; and may be added with Ag component in a form of compound selected from Ag, AgNO₃, AgCl and Ag₂SO₄. Also, the acid-treatment method for the catalyst according to the present invention may be any one of using the aqueous sulfuric acid or passing by sulfur dioxide onto the catalyst.

As a preferred embodiment of the present invention, the titania carrier can be supported by a structure selected from a group consisting of metallic panel, bag filter, ceramic filter, ceramic honeycomb and ceramic corrugate honeycomb depending on its applications and/or uses before beginning the step (a) to impregnate the catalyst with the metals among the entire process described above. Alternative embodiment of the present invention may be a molding process of the catalyst to form the catalyst in a form of any one selected from a group consisting of sphere, pellet and honeycomb.

The present invention will be more clearly understood by the following examples which are just for illustrating the present invention, and is not limited by the said examples. Different variations and modifications of the invention can be proposed without departing from the scope of the present invention.

### EXAMPLES

### Example 1

Preparation of Vanadium-Molybdenum/Titania Catalyst [V—Mo/TiO₂]

In deionized water, oxalic acid (C₂H₂O₄.2H₂O, manufactured by DUKSAN PURE CHEMICALS CO., LTD., KOREA) was introduced and, after stirring the solution, ammonium metavanadate (NH₄VO₃, manufactured by Samchun Pure Chemical Co. Ltd., KOREA) and ammonium molybdate ((NH₄)Mo₇O₂₄.4H₂O, manufactured by DUKSAN PURE CHEMICALS CO., LTD., KOREA) together were charged in the solution then dissolved by strongly agitating it. As an aqueous pre-catalyst solution, such solution was gradually added with titania DT51 (available from Millennium, FRANCE; with a specified crystal structure—anatase 100%, specific surface area:80 to 100 m²/g, SO₃ content:1 to 2% by weight) followed by strong agitation to produce a homogeneous slurry. Herein, the materials such as titania, ammonium metavanadate, ammonium molybdate had been added in a weight ratio of 25.93:1:2.55 in order to produce the slurry. The prepared slurry was coated onto surface of a codierite honeycomb (FACTOP KOCAT Co., KOREA) form article having a dimension of 15×15×30 cm and a cell density of 46 cells/in²(40×40 cells) and was naturally dried overnight. Afterward, by drying the article at 120° C. for 4 hours then raising the temperature up to 500° C. by 10° C. per minute and calcinating the treated article at the same temperature for 2 hours, the purposed vanadium-molybdenum/titania catalyst was obtained. The produced catalyst comprised 0.84% by weight of vanadium and 5.33% by weight of molybdenum based on titania.

### Example 2

Preparation of Silver-Vanadium-Molybdenum/Titania Catalyst [Ag—V—Mo/TiO₂]

The catalyst produced in Example 1 was impregnated in silver nitrate (AgNO₃, produced by Han-Gyeul Gold Co., KOREA) then naturally dried overnight. Subsequently, by drying the catalyst at 120° C. for 4 hours then raising the temperature up to 500° C. by 10° C. per minute and calcinating the catalyst at the same temperature for 2 hours, the purposed silver-vanadium-molybdenum/titania catalyst was obtained. The produced catalyst comprised 0.84% by weight of vanadium and 5.33% by weight of molybdenum and 2% by weight of silver based on titania.

### Example 3

Preparation of Silver-Vanadium-Molybdenum/Titania-Sulfuric Acid Catalyst [Ag—V—Mo/TiO₂—SO₄²⁻]

The catalyst produced in Example 2 was impregnated in 0.21M aqueous sulfuric acid solution (H₂SO₄.xSO₃, produced by Aldrich, USA) then naturally dried overnight. Subsequently, by drying the catalyst at 120° C. for 4 hours then raising the temperature up to 500° C. by 10° C. per minute and calcinating the catalyst, the purposed silver-vanadium-molybdenum/titania-sulfuric acid catalyst was obtained. The produced catalyst comprised 0.84% by weight of vanadium and 5.33% by weight of molybdenum, 2% by weight of silver and 2% by weight of sulfate based on-titania.

### Example 4

Determination of 1,2-dichlorobenzene removal efficiency.

It is commonly known that aromatic halogenated compound such as dioxin is very toxic and hard to analyze, and requires expensive analysis equipments and high expense. However, for an experiment to remove dioxin by applying the present inventive catalyst, 1,2-dichlorobenzene was employed as a reactant model conventionally used in studying catalysts for removing dioxin, having a structure similar to but higher activity than the dioxin in view of bonding reaction ability.

The experiment for removing 1,2-dichlorobenzene was conducted by using three catalysts prepared in Examples 1, 2, and 3 and according to the following process.

Firstly, in a reactor made of SUS 304 (manufactured by SAMSON HIGHTEC, Korea) honeycomb catalyst cut pieces prepared in Examples 1, 2 and 3, each having 3×3×5 cm dimension, were charged in the middle of the reactor. The reaction temperature was controlled to about 100 to 600° C. by means of electric furnace (7 Kw, SAMSON HIGHTEC, Korea) and temperature controller (LIP350, Yokogawa Electric Co., Japan) and determined by K type thermocouples.

As the reactant, 20 ml of 1,2-dichlorobenzene (C₆H₄C₁₂, Aldrich, USA) was charged in a Pyrex bubble bottle (DAIHAN Scientific, co., Ltd., Korea) then located into a water bath with constant temperature (LCB-R12, DAIHAN Scientific, co., Ltd., Korea), followed by regulating flow rate of air as a balance gas by means of mass flow rate controller (F-201C-FAC-22-V, Bronkhorst, Netherlands) to maintain the concentration of 1,2-dichlorobenzene to about 260 to 340 ppm. Flow rate of the entire air was controlled by another mass flow rate controller (F-201D-FAC-22-E, Bronkhorst, Netherlands) to keep the space velocity of 4,000 hr⁻¹.

Concentration of 1,2-dichlorobenzene before and after the reaction were analyzed by Gas Chromatography DS6200 (DONAM Instrument, Korea) equipped with Flame Ionization Detector (FID, VICI, USA) and Capillary column BPX 608 (SGE, USA) and conversion rate of 1,2-dichlorobenzene on each of the catalysts was calculated by the following equation 1:

Conversion rate of 1,2-dichlorobenzene (%)=[(concentration of 1,2-dichlorobenzene before the reaction−concentration of 1,2-dichlorobenzene after the reaction)/concentration of 1,2-dichlorobenzene before the reaction]×100 Equation 1:

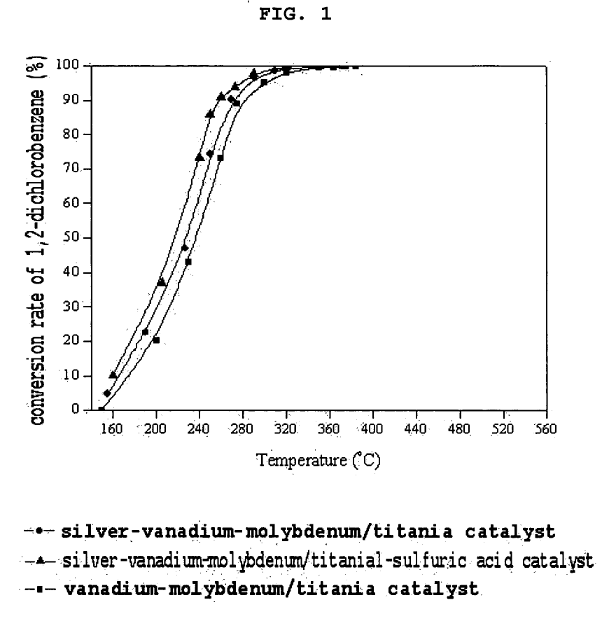

The conversion rate of 1,2-dichlorobenzene on each of the catalysts was shown in FIG. 1. From FIG. 1, the catalyst produced in Example 1 which was a control compared to the present inventive catalyst was referred to as “vanadium-molybdenum/titania catalyst”, while mentioning the present catalysts produced in Examples 2 and 3 as “silver-vanadium-molybdenum/titania catalyst” or “silver-vanadium-molybdenum/titania-sulfuric acid catalyst”, respectively.

As illustrated in FIG. 1, it was found that the removal efficiency of 1,2-dichlorobenzene was much higher for the present catalysts which were produced by adding Ag as a cocatalyst or conducting sulfuric acid-treatment after impregnating the catalyst with sulfuric acid, compared to the catalyst from Example 1.

### Example 5

Determination of carbon monoxide removal efficiency.

The experiment for removing carbon monoxide was conducted by using three catalysts prepared in Examples 1, 2, and 3.

The experiment was conducted according to the same manner as in Example 4 except that the reactant was replaced by carbon monoxide. By using a mass flow rate controller (F-201C-FAC-11-V, Bronkhorst, Netherlands) to keep the flow rate of gas flowing out of a gas container (DaeDeok GAS co., Ltd., Korea) charged with 5% nitrogen containing carbon monoxide, concentration of the reactant carbon monoxide was constantly kept to 1,000 ppm. The flow rate of the entire air was regulated by means of another mass flow rate controller (F-201D-FAC-22-E, Bronkhorst, Netherlands) to maintain the space velocity of 4,000 hr⁻¹.

Concentration of carbon monoxide before and after the reaction were analyzed by a portable gas analyzer MK2 (EUROTRON Instruments, Italy) and conversion rate thereof was calculated by the following equation 2:

Conversion rate of carbon monoxide (%)=[(concentration of carbon monoxide before the reaction−concentration of carbon monoxide after the reaction)/concentration of carbon monoxide before the reaction]×100 Equation 2:

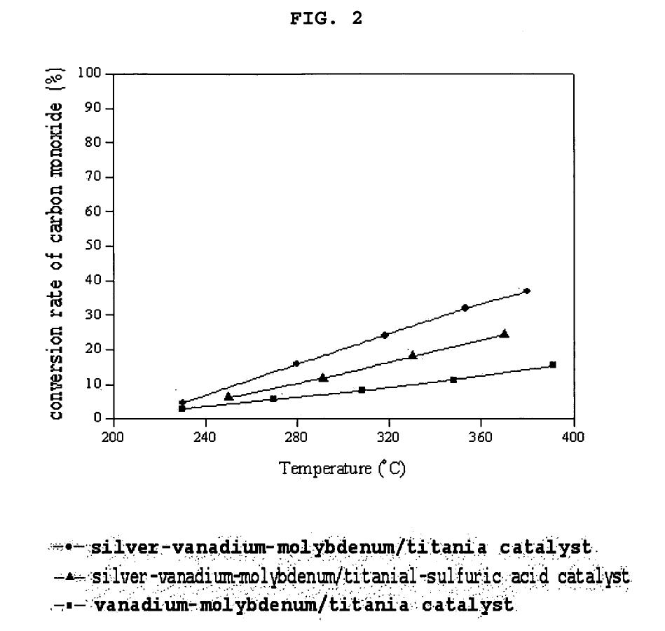

The conversion rate of carbon monoxide on each of the catalysts was shown in FIG. 2. From FIG. 2, the catalyst produced in Example 1 which was a control compared to the present inventive catalyst was referred to as “vanadium-molybdenum/titania catalyst”, while mentioning the present catalysts produced in Examples 2 and 3 as “silver-vanadium-molybdenum/titania catalyst” or “silver-vanadium-molybdenum/titania-sulfuric acid catalyst”, respectively.

As illustrated in FIG. 2, it was identified that the removal efficiency of carbon monoxide was much higher for the present catalysts which were produced by adding Ag as a cocatalyst or conducting sulfuric acid-treatment after impregnating the catalyst with sulfuric acid, compared to the catalyst from Example 1.

### Example 6

Determination of nitrogen oxide removal efficiency.

The experiment for removing nitrogen oxide was conducted by using three catalysts prepared in Examples 1, 2, and 3.

Firstly, in a reactor made of SUS 304 (manufactured by SAMSON HIGHTEC, Korea) honeycomb catalyst cut pieces prepared in Examples 1, 2 and 3, each having 3×3×5 cm dimension, were charged in the middle of the reactor. The reaction temperature was controlled to about 100 to 600° C. by means of electric furnace (7 Kw, SAMSON HIGHTEC, Korea) and temperature controller (LIP350, YOKOGAWA, Japan) and determined by K type thermocouples.

By using a mass flow rate controller (F-201C-FAC-11-V, Bronkhorst, Netherlands) to keep flow rate of the gas flowing out of a gas container charged with 1% nitrogen oxide, concentration of the reactant nitrogen oxide was constantly kept to 120 ppm. The flow rate of the entire air was regulated by means of alternative mass flow rate controller (F-201D-FAC-22-E, Bronkhorst, Netherlands) to maintain the space velocity of 10,000 hr⁻.

As a reducing agent, ammonia in a form of 25% aqueous ammonia solution (DUKSAN Chemical Industries, Korea) was introduced to the nitrogen oxide by a pump M930 (YOUNGLIN Instrumental, Korea) to regulate relative amount of the reducing agent to the nitrogen oxide in 1:1 molar ratio.

For the catalysts treated as above, activity analysis was carried out at every 50° C. Concentration of nitrogen oxide before and after the reaction were analyzed by a portable gas analyzer MK2 (EUROTRON, Italy) and conversion rate thereof was calculated by the following equation 3:

Conversion rate of nitrogen oxide (%)=[(concentration of nitrogen oxide before the reaction−concentration of nitrogen oxide after the reaction)/concentration of nitrogen oxide before the reaction]×100 Equation 3:

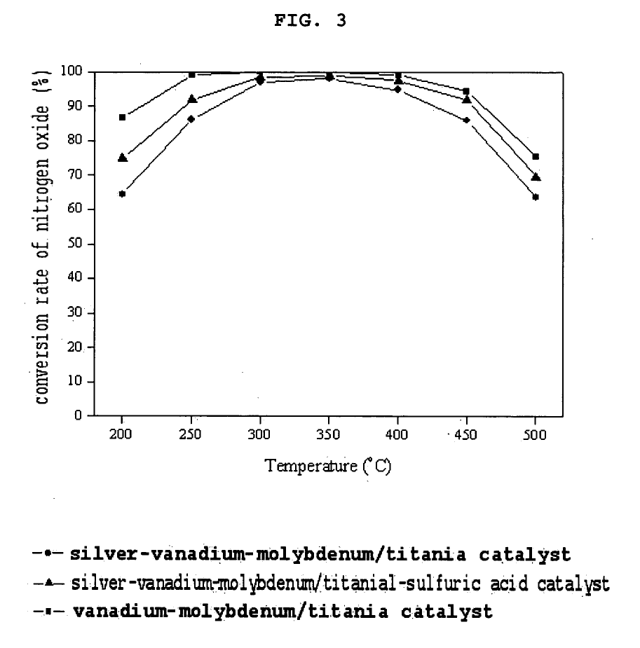

The conversion rate of nitrogen oxide on each of the catalysts was shown in FIG. 3. From FIG. 3, the catalyst produced in Example 1 which was a control compared to the present inventive catalyst was referred to as “vanadium-molybdenum/titania catalyst”, while mentioning the present catalysts produced in Examples 2 and 3 as “silver-vanadium-molybdenum/titania catalyst” or “silver-vanadium-molybdenum/titania-sulfuric acid catalyst”, respectively.

As illustrated in FIG. 3, it was identified that the removal efficiency of nitrogen oxide for the present catalysts which were produced by adding Ag as a cocatalyst or conducting sulfuric acid-treatment after impregnating the catalyst with sulfuric acid was substantially equal to the catalyst from Example 1.

### Example 7

Preparation of Vanadium-Tungsten/Titania Catalyst [V—W/TiO₂]

According to the same manner as in Example 1 except that ammonium paratungstate ((NH₄)₁₀W₁₂O₄₁, Aldrich, USA) was used in place of ammonium molybdate ((NH₄)Mo₇O₂₄.4H₂O, manufactured by DUKSAN PURE CHEMICALS CO., LTD., KOREA), the vanadium-tungsten/titania catalyst was prepared. Herein, the materials such as titania, ammonium metavanadate, ammonium paratungstate have been added in a weight ratio of 25.93:1:2.34 in order to produce the slurry. The produced catalyst comprised 0.84% by weight of vanadium and 6.34% by weight of tungsten based on titania.

### Example 8

Preparation of Silver-Vanadium-Tungsten/Titania Catalyst [Ag—V—W/TiO₂]

The catalyst produced in Example 7 was impregnated in silver nitrate (AgNO₃, produced by Han-Gyeul Gold Co., KOREA) then naturally dried overnight. Subsequently, by drying the catalyst at 120° C. for 4 hours then raising the temperature up to 500° C. by 10° C. per minute and calcinating the catalyst at the same temperature for 2 hours, the purposed silver-vanadium-tungsten/titania catalyst was obtained. The produced catalyst comprised 2% by weight of Ag, 0.84% by weight of vanadium and 6.34% by weight of tungsten based on titania.

### Example 9

Preparation of Silver-Vanadium-Tungsten/Titania-Sulfuric Acid Catalyst [Ag—V—W/TiO₂—SO₄²⁻]

The catalyst produced in Example 8 was impregnated in 0.21M aqueous sulfuric acid solution (H₂SO₄.xSO₃, produced by Aldrich, USA) then naturally dried overnight. Subsequently, by drying the catalyst at 120° C. for 4 hours then raising the temperature up to 500° C. by 10° C. per minute and calcinating the catalyst, the purposed silver-vanadium-tungsten/titania-sulfuric acid catalyst was obtained. The produced catalyst comprised 2% by weight of silver, 0.84% by weight of vanadium and 6.34% by weight of tungsten and 2% by weight of sulfate based on titania.

### Example 10

Determination of 1,2-dichlorobenzene Removal Efficiency.

The experiment for removing 1,2-dichlorobenzene was conducted by using three catalysts prepared in Examples 7, 8, and 9 according to the same manner as in Example 4.

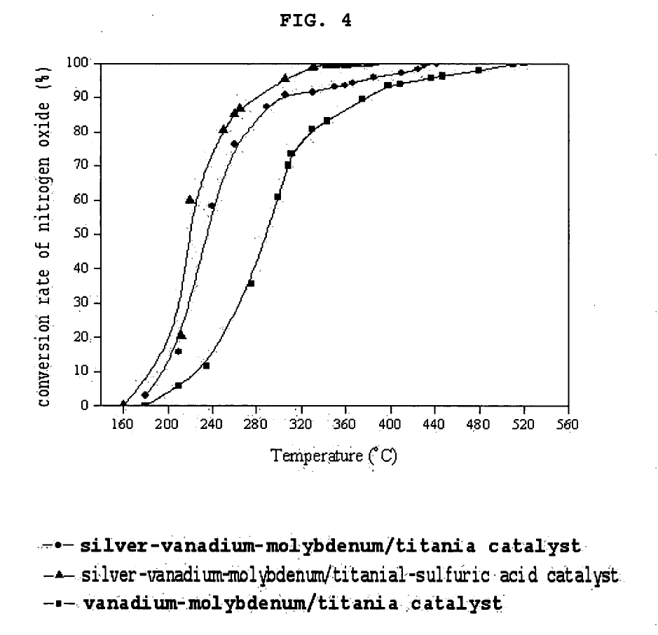

The conversion rate of 1,2-dichlorobenzene on each of the catalysts was shown in FIG. 4. From FIG. 4, the catalyst produced in Example 7 which is a control compared to the present inventive catalyst was referred to as “vanadium-tungsten/titania catalyst”, while mentioning the present catalysts produced in Examples 8 and 9 as “silver-vanadium-tungsten/titania catalyst” or “silver-vanadium-tungsten/titania-sulfuric acid catalyst”, respectively.

As illustrated in FIG. 4, it was found that the removal efficiency of 1,2-dichlorobenzene was much higher for the present catalysts which were produced by adding Ag as a cocatalyst or conducting sulfuric acid-treatment after impregnating the catalyst with sulfuric acid, compared to the catalyst from Example 7.

### Example 11

Determination of carbon monoxide removal efficiency.

The experiment for removing carbon monoxide was conducted by using three catalysts prepared in Examples 7, 8, and 9 according to the same manner as in Example 5.

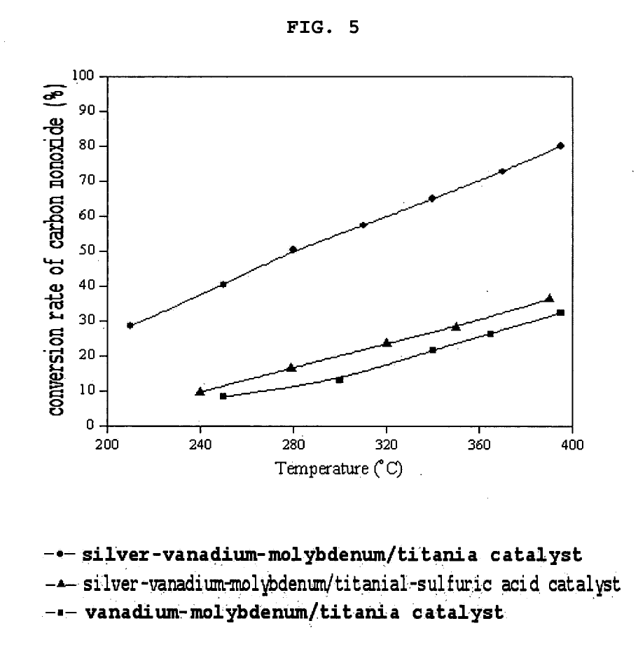

The conversion rate of carbon monoxide on each of the catalysts was shown in FIG. 5. From FIG. 5, the catalyst produced in Example 7 which is a control compared to the present inventive catalyst was referred to as “vanadium-tungsten/titania catalyst”, while mentioning the present catalysts produced in Examples 8 and 9 as “silver-vanadium-tungsten/titania catalyst” or “silver-vanadium-tungsten/titania-sulfuric acid catalyst”, respectively.

As illustrated in FIG. 5, it was found that the removal efficiency of carbon monoxide was much higher for the present catalysts which were produced by adding Ag as a cocatalyst or conducting sulfuric acid-treatment after impregnating the catalyst with sulfuric acid, compared to the catalyst from Example 7.

### Example 12

Determination of nitrogen oxide removal efficiency.

The experiment for removing nitrogen oxide was conducted by using three catalysts prepared in Examples 7, 8, and 9 according to the same manner as in Example 6.

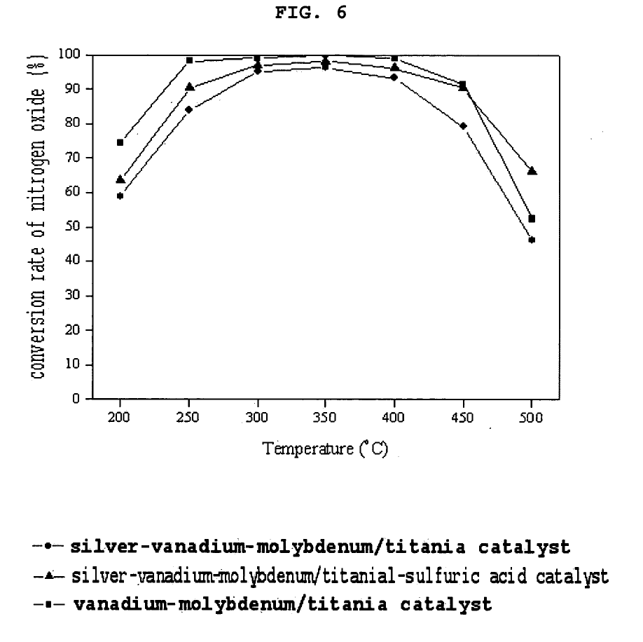

The conversion rate of nitrogen oxide on each of the catalysts was shown in FIG. 6. From FIG. 6, the catalyst produced in Example 7 which is a control compared to the present inventive catalyst was referred to as “vanadium-tungsten/titania catalyst”, while mentioning the present catalysts produced in Examples 8 and 9 as “silver-vanadium-tungsten/titania catalyst” or “silver-vanadium-tungsten/titania-sulfuric acid catalyst”, respectively.

As illustrated in FIG. 6, it was found that the removal efficiency of carbon monoxide for the present catalysts which were produced by adding Ag as a cocatalyst or conducting sulfuric acid-treatment after impregnating the catalyst with sulfuric acid was substantially equal to the catalyst from Example 7.

From results of the above examples, it can be understood that the present inventive catalyst does not adversely effect the activity of catalyst to remove nitrogen oxide and can efficiently remove both of aromatic halogenated compound comprising dioxin and carbon monoxide simultaneously. Therefore, the catalyst according to the present invention can overcome known problems in conventional catalyst systems and attain an effective and economical treatment of exhaust gas.

As clearly described above, those skilled in related arts will appreciate that various changes and/or modifications of the present invention are possible without altering important technical features or departing from spirit and/or scope of the present invention. In this regards, although the examples described in the detailed description have been proposed only for illustrative purposes, the present invention includes all of modifications, additions, substitutions and equivalents and is restricted by only as disclosed in the accompanying claims.

### INDUSTRIAL APPLICABILITY

The catalyst according to the present invention has improved efficiency for removing 1,2-dichlorobenzene as a reactant model of dioxin and carbon monoxide rather than existing catalysts and has substantially the same efficiency for removing nitrogen oxide, compared to commonly known catalysts.

The present disclosure relates to subject matter contained in Korean Patent Application No. 2002-0028373, filed on May 3, 2003, the contents of which is herein expressly incorporated by reference in its entirety.

1. A catalyst comprising 0.1 to 5% by weight of vanadium, 1 to 12% by weight of any metal from 6A family and 0.1 to 10% by weight of Ag in 70 to 99% by weight of titania useful to remove the aromatic halogenated compounds comprising dioxin, carbon monoxide and nitrogen oxides simultaneously.

2. The catalyst according to claim 1, wherein the catalyst undergoes further acid-treatment useful to remove the aromatic halogenated compounds comprising dioxin, carbon monoxide and nitrogen oxides simultaneously.

3. The catalyst according to claim 2, wherein the acid-treatment is conducted by impregnating said catalyst in 0.05 to 1M aqueous sulfuric acid solution and drying and calcinating the impregnated catalyst, or by passing by sulfur dioxide onto said catalyst useful to remove the aromatic halogenated compounds comprising dioxin, carbon monoxide and nitrogen oxides simultaneously.

4. The catalyst according to claim 1, wherein said titania has any one crystal structure selected from a group consisting of amorphous type, anatase type and rutile type crystal structures useful to remove the aromatic halogenated compounds comprising dioxin, carbon monoxide and nitrogen oxides simultaneously.

5. The catalyst according to claim 1, wherein said 6A metal is any one selected from a group consisting of molybdenum, tungsten and chromium useful to remove the aromatic halogenated compounds comprising dioxin, carbon monoxide and nitrogen oxides simultaneously.

6. The catalyst according to claim 1, wherein said Ag is any one selected from a group consisting of silver nitrate, silver chloride, silver sulfate or a combinations thereof useful to remove the aromatic halogenated compounds comprising dioxin, carbon monoxide and nitrogen oxides simultaneously.

7. The catalyst according to claim 1, wherein said catalyst is supported by a structure selected from a group consisting of metallic panel, bag filter, ceramic filter, ceramic honeycomb and ceramic corrugate honeycomb useful to remove the aromatic halogenated compounds comprising dioxin, carbon monoxide and nitrogen oxides simultaneously.

8. The catalyst according to claim 1, wherein said catalyst is molded to form any one selected from a group consisting of sphere, pellet and honeycomb useful to remove the aromatic halogenated compounds comprising dioxin, carbon monoxide and nitrogen oxides simultaneously.

9. The catalyst according to claim 2, wherein said titania has any one crystal structure selected from a group consisting of amorphous type, anatase type and rutile type crystal structures useful to remove the aromatic halogenated compounds comprising dioxin, carbon monoxide and nitrogen oxides simultaneously.

10. The catalyst according to claim 3, wherein said titania has any one crystal structure selected from a group consisting of amorphous type, anatase type and rutile type crystal structures useful to remove the aromatic halogenated compounds comprising dioxin, carbon monoxide and nitrogen oxides simultaneously.

11. The catalyst according to claim 2, wherein said 6A metal is any one selected from a group consisting of molybdenum, tungsten and chromium useful to remove the aromatic halogenated compounds comprising dioxin, carbon monoxide and nitrogen oxides simultaneously.

12. The catalyst according to claim 3, wherein said 6A metal is any one selected from a group consisting of molybdenum, tungsten and chromium useful to remove the aromatic halogenated compounds comprising dioxin, carbon monoxide and nitrogen oxides simultaneously.

13. The catalyst according to claim 2, wherein said Ag is any one selected from a group consisting of silver nitrate, silver chloride, silver sulfate or a combinations thereof useful to remove the aromatic halogenated compounds comprising dioxin, carbon monoxide and nitrogen oxides simultaneously.

14. The catalyst according to claim 3, wherein said Ag is any one selected from a group consisting of silver nitrate, silver chloride, silver sulfate or a combinations thereof useful to remove the aromatic halogenated compounds comprising dioxin, carbon monoxide and nitrogen oxides simultaneously.

15. The catalyst according to claim 2, wherein said catalyst is supported by a structure selected from a group consisting of metallic panel, bag filter, ceramic filter, ceramic honeycomb and ceramic corrugate honeycomb useful to remove the aromatic halogenated compounds comprising dioxin, carbon monoxide and nitrogen oxides simultaneously.

16. The catalyst according to claim 3, wherein said catalyst is supported by a structure selected from a group consisting of metallic panel, bag filter, ceramic filter, ceramic honeycomb and ceramic corrugate honeycomb useful to remove the aromatic halogenated compounds comprising dioxin, carbon monoxide and nitrogen oxides simultaneously.

17. The catalyst according to claim 2, wherein said catalyst is molded to form any one selected from a group consisting of sphere, pellet and honeycomb useful to remove the aromatic halogenated compounds comprising dioxin, carbon monoxide and nitrogen oxides simultaneously.

18. The catalyst according to claim 3, wherein said catalyst is molded to form any one selected from a group consisting of sphere, pellet and honeycomb useful to remove the aromatic halogenated compounds comprising dioxin, carbon monoxide and nitrogen oxides simultaneously.
